(19) United States
(12) Patent Application Publication
(10) Pub. No.: US 2017/0067274 A1
(43) Pub. Date: Mar. 9, 2017

(54) FASTENING DEVICES

(71) Applicants: KOJIMA INDUSTRIES CORPORATION, Toyota-shi (JP); TOYOTA JIDOSHA KABUSHIKI KAISHA, Toyota-shi (JP)

(72) Inventors: Toshiki YANO, Toyota-shi (JP); Toshinao WADA, Miyoshi-shi (JP)

(21) Appl. No.: 15/255,982

(22) Filed: Sep. 2, 2016

(30) Foreign Application Priority Data
Sep. 4, 2015 (JP) 2015-174806

(51) Int. Cl. E05B 83/32; E05C 9/02; E05C 3/34

(52) U.S. Cl. CPC E05B 83/32; E05C 3/34; E05C 9/02

(57) ABSTRACT

A lid fastening device configured to fasten a lid of an object member and capable of opening and closing an opening formed in the object member includes a knob, and a rod configured to slide from an initial position when the knob is pushed. In addition, the device includes strikers each having an engagement claw capable of engaging engagement portions formed in the object member and each being configured to rotate between an initial position in which each of the engagement claws engages the engagement portions to produce a fastened condition of the lid and a released position in which the fastened condition of the lid is released due to a sliding motion of the rod. Further, the device includes return springs that are configured to bias each of the strikers rotated to the released position so as to return the same to the initial position with the rod.

### CROSS-REFERENCE TO RELATED APPLICATIONS

This application claims benefit of Japanese patent application Serial No. 2015-174806 filed Sep. 4, 2015 which is hereby incorporated herein by reference in its entirety.

### STATEMENT REGARDING FEDERALLY SPONSORED RESEARCH OR DEVELOPMENT

Not applicable.

### BACKGROUND

The present disclosure relates to locking or fastening devices. More specifically, the present disclosure relates to lid fastening (locking) devices for a lid of a vehicle storage box or compartment (e.g., a glove box, a consol box or other such compartments).

A known fastening device is taught, for example, by JP 2009-269572A. The fastening device is intended to fasten (lock) a lid of a glove box to an instrument panel. The fastening device includes a pair of engagement rods attached to the lid. The engagement rods are linked via a pinion, so as to slide in synchrony with each other. Further, a biasing force is applied to the engagement rods in a direction in which the engagement rods are thrust into engagement holes formed in the instrument panel. When the engagement rods are introduced into the engagement holes, the lid may be locked or fastened to the instrument panel. Further, a manipulation knob is attached to the lid. When the manipulation knob is pushed or pressed, the engagement rods move in synchrony with each other, so as to respectively be drawn from the engagement holes. Thus, the lid may be unfastened.

In this known device, the engagement rods are previously integrated with the pinion before the engagement rods are attached to the lid. However, an operation to integrate the engagement rods with the pinion needs a specialized tool or jig. This may lead to increased manufacturing costs of the fastening device.

Thus, there is a need in the art for an improved fastening device for a lid of a vehicle storage compartment.

### SUMMARY

In one aspect of the present disclosure, a lid fastening device that is configured to fasten a lid attached to an object member and capable of opening and closing an opening formed therein in a condition in which the opening is closed by the lid and to unfasten the lid may include a knob, a rod configured to slide from an initial position when the knob is pushed, strikers each of which has an engagement claw capable of engaging each of engagement portions formed in the object member and is configured to rotate between an initial position in which each of the engagement claws engages each of the engagement portions of the object member to produce a fastened condition of the lid and a released position in which the fastened condition of the lid is released due to a sliding motion of the rod, and return springs each of which is configured to bias each of the strikers rotated to the released position so as to return the same to the initial position with the rod.

According to this aspect, the lid fastening device may be easily incorporated into the lid without using a specialized tool or jig.

Other objects, features and advantage of the present disclosure will be readily understood after reading the following detailed description together with the accompanying drawings and the claims.

### BRIEF DESCRIPTION OF THE DRAWINGS

FIG. 1 is a perspective view of a center consol box having a lid into which a fastening device according to a representative embodiment is incorporated, in which a lid is closed;

FIG. 2 is a perspective view of the center consol box, in which the lid is opened;

FIG. 3 is an exploded perspective view of the lid and lid attaching members;

FIG. 4 is an enlarged perspective view of an inner member of the lid, which is viewed from above;

FIG. 5 is an enlarged perspective view of the inner member of the lid and the lid attaching members, which is viewed from below;

FIG. 6 is an exploded perspective view of the inner member of the lid;

FIG. 7 is a plan view of FIG. 4;

FIG. 8 is an enlarged cross-sectional view taken along line VIII-VIII in FIG. 7;

FIG. 9 is an enlarged cross-sectional view taken along line IX-IX in FIG. 7;

FIG. 10 is an enlarged cross-sectional view taken along line X-X in FIG. 7;

FIG. 11 is an enlarged cross-sectional view taken along line XI-XI in FIG. 7;

FIG. 12 is an enlarged cross-sectional view taken along line XII-XII in FIG. 7; and

FIG. 13 is an enlarged cross-sectional view taken along line XIII-XIII in FIG. 7.

### DETAILED DESCRIPTION

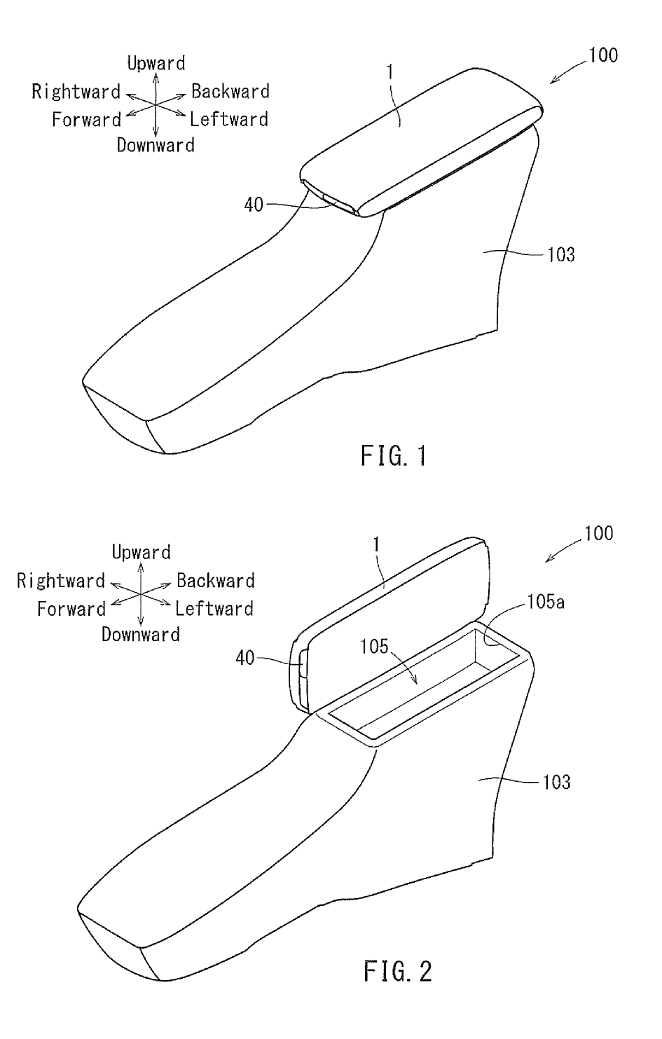

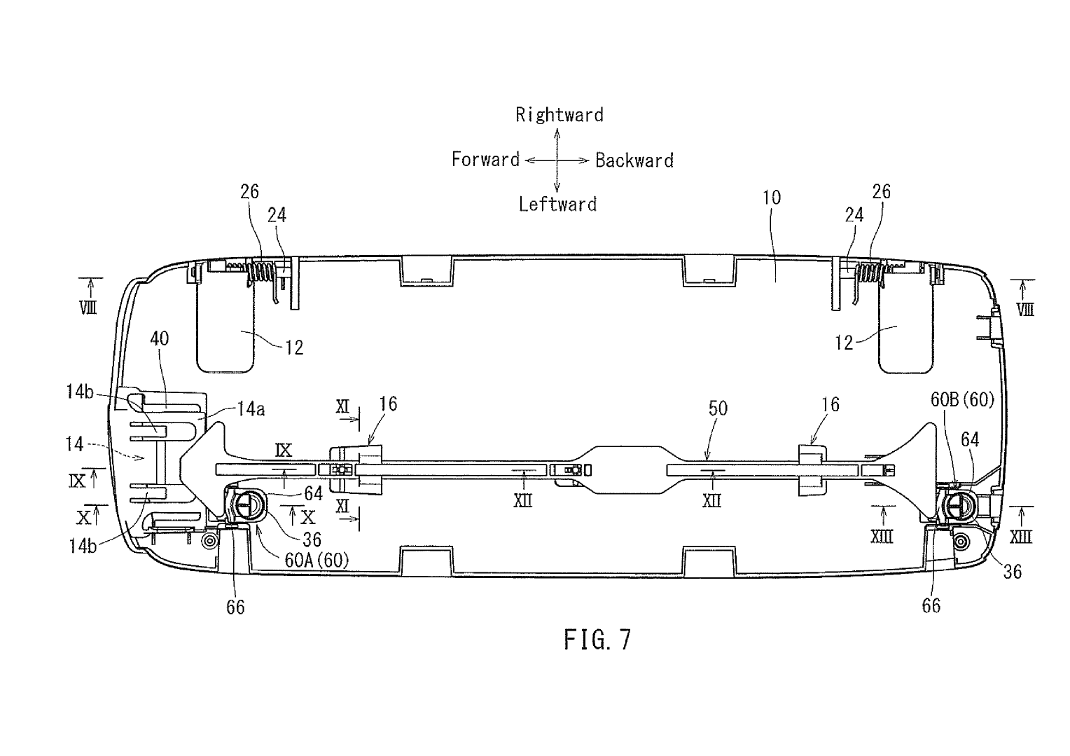

A representative embodiment will now be described in detail with reference to FIGS. 1 to 13.

In this embodiment, a center consol box 100 (FIGS. 1 and 2) is exemplified as a vehicle storage compartment. As will be recognized, the center consol box 100 is designed for a left-hand drive vehicle (e.g., car). Further, forward and backward, rightward and leftward, and upward and downward in the drawings respectively correspond to forward and backward, rightward and leftward, and upward and downward of the vehicle.

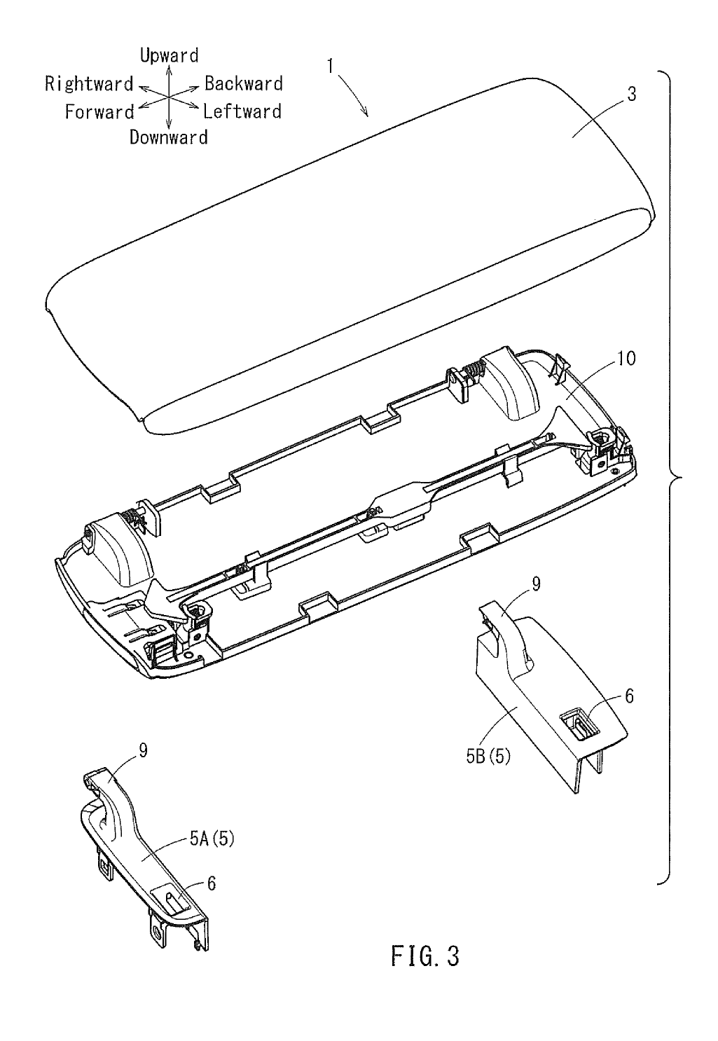

As shown in FIGS. 1 and 2, the center consol box 100 may be composed of a consol body 103 (a main body), a lid 1 into which a lid fastening (locking) device (which will be hereinafter described) is incorporated, and a pair of lid attaching members 5 (see FIG. 3). As shown in FIG. 2, the consol body 103 may have an open-topped box-shaped storage portion 105. The lid 1 may be constructed to cover or close an opening 105a of the storage portion 105. The lid 1 may be rotatably connected to the consol body 103 via the lid attaching members 5, so as to close and open the opening 105a of the storage portion 105. Further, the lid attaching members 5 may be arranged and constructed such that the lid 1 may be opened and closed to right and left about a right periphery of the opening 105a.

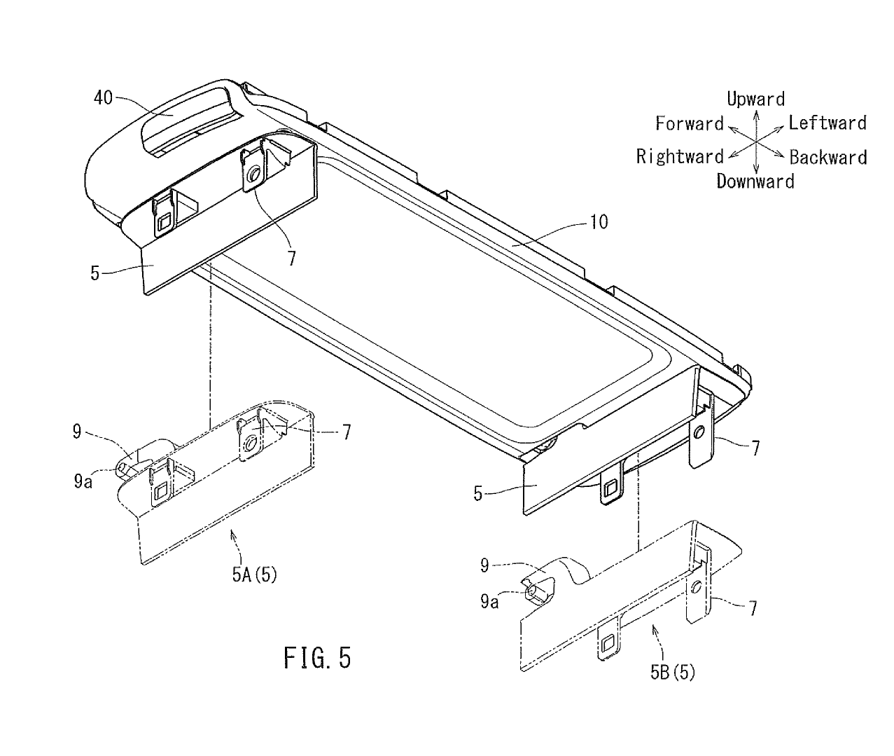

As shown in FIG. 3, the lid 1 is composed of an outer member 3 and a plate-shaped inner (base) member 10. The outer member 3 may be coupled to the inner member 10 while covering an upper surface of the inner member 10. As shown in FIG. 5, the lid attaching members 5 may be positioned on a lower surface of the inner member 10 in order to rotatably connect the lid 1 to the consol body 103. Further, the lid attaching members 5 may be fixed to the console body 103 via fixing brackets 7.

As shown in FIG. 5, the lid attaching members 5 may be separately positioned on front and rear portions of the inner member 10. Therefore, the lid attaching members 5 may respectively be referred to as a first (front) lid attaching member 5A and a second (rear) lid attaching member 5B. Further, the first and second lid attaching members 5A and 5B may have the substantially same structure as each other. Therefore, elements that are the functionally same in the first and second lid attaching members 5A and 5B will be identified by the same reference numerals in order to avoid repetition in a description of such elements.

As shown in FIGS. 3 and 5, the lid attaching members 5 (5A and 5B) may respectively have hook-shaped shaft insertion portions 9 that are arcuately projected upward. Each of the shaft insertion portions 9 may have a through hole 9a that is formed therein so as to extend back and forth.

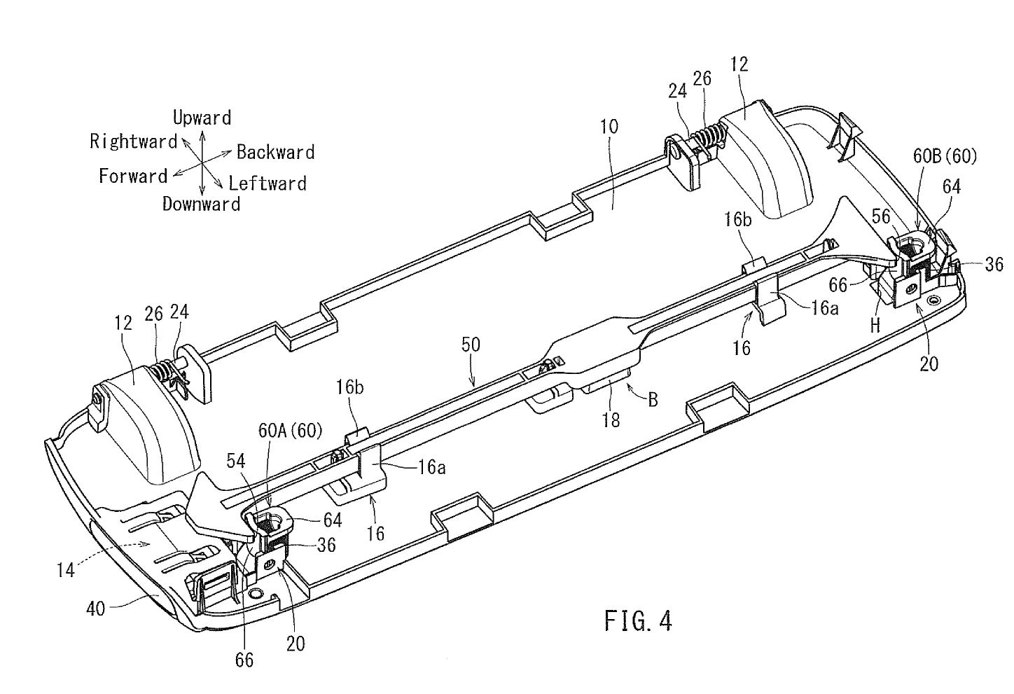

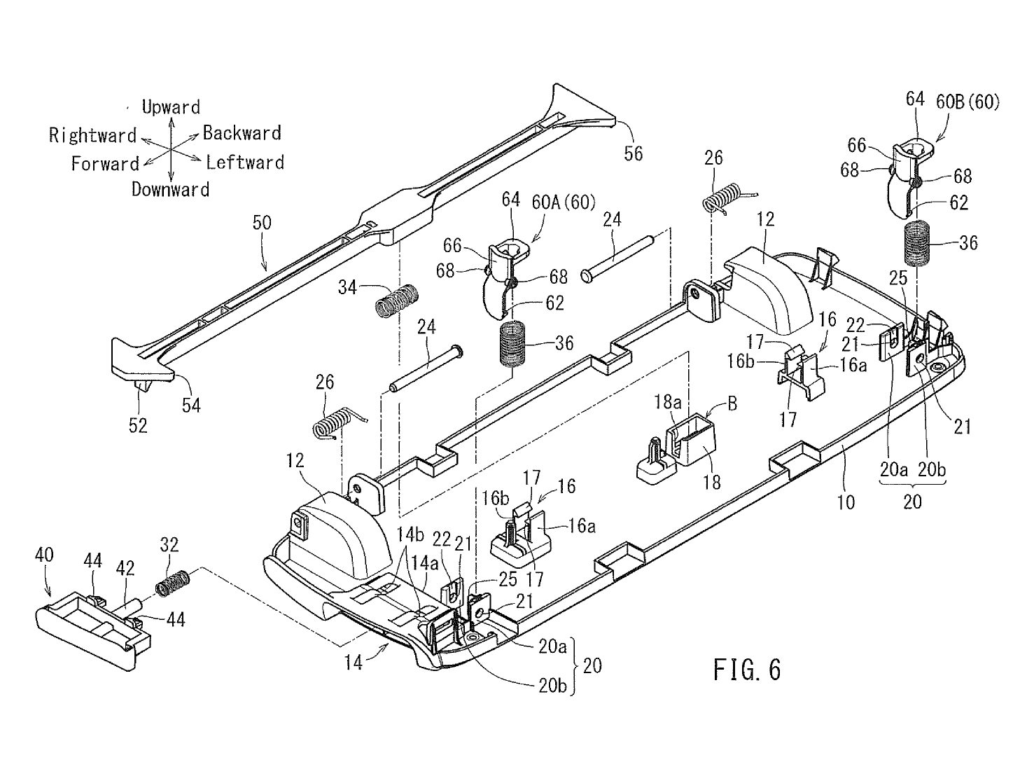

Conversely, as shown in FIGS. 4 and 6, the inner member 10 may have a pair of (front and rear) curved recessed portions 12 that are bulged upward. The recessed portions 12 may be formed in a right periphery of the inner member 10 at a certain interval in a front-back direction. As will be recognized, the recessed portions 12 may be arranged and constructed to loosely receive the shaft insertion portions 9 of the lid attaching members 5. Further, the inner member 10 may have a pair of (front and rear) rotation axes 24 attached thereto. Example of the rotation axes 24 are pins. The rotation axes 24 may respectively be positioned so as to pass through the recessed portions 12 in the backward and forward direction.

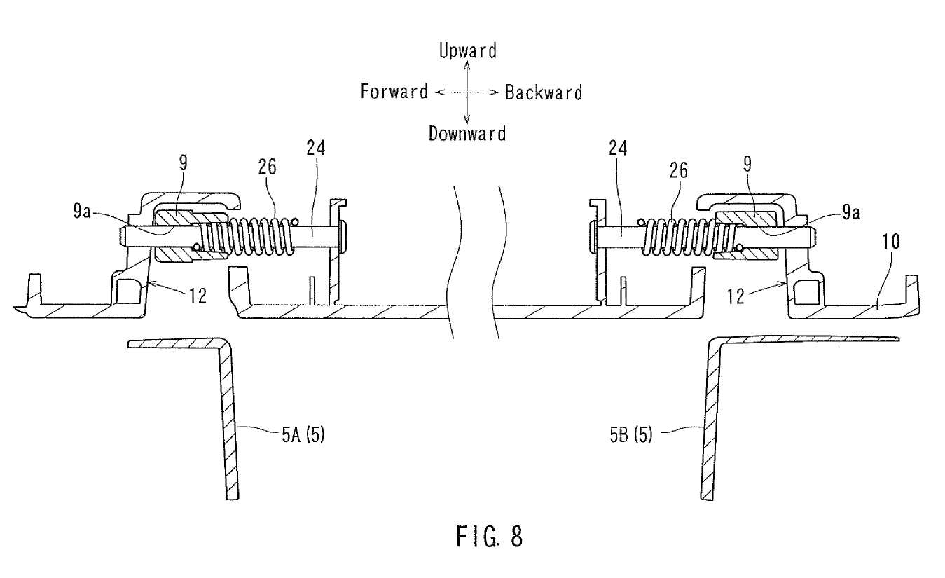

As shown in FIG. 8, the shaft insertion portions 9 of the lid attaching members 5 may be received in the recessed portions 12 of the inner member 10 while the rotation axes 24 attached to the inner member 10 are respectively inserted into the through holes 9a of the shaft insertion portions 9. As a result, the inner member 10 may be attached to the lid attaching members 5 so as to be rotatable about the shaft insertion portions 9 of the lid attaching members 5 via the rotation axes 24. Thus, the lid 1 may be rotatably connected to the consol body 103 via the lid attaching members 5, so as to close and open the opening 105a of the storage portion 105.

As shown in FIGS. 4 and 6 to 8, torsion springs 26 may respectively be attached to the rotation axes 24. One end of each of the torsion springs 26 may be supported on the inner member 10 and the other end of each of the torsion springs may be supported on the shaft insertion portions 9 of the corresponding lid attaching members 5 such that the lid 1 (the inner member 10) may normally be biased in a direction to uncover or open the opening 105a of the storage portion 105. Therefore, when the fastening device incorporated into the lid 1 is released, the lid 1 may be automatically opened due to a biasing or spring force of the torsion springs 26, so that the opening 105a of the storage portion 105 may be uncovered or opened (FIG. 2). Further, in order to close the lid 1, the lid 1 may be simply pressed down against the spring force of the torsion spring 26.

Next, the fastening device incorporated into the lid 1 will be described. As shown in FIGS. 4 and 6, the fastening device may be essentially composed of a manipulation knob 40 (i.e., a manipulation member) attached to the inner member 10, a rod 50 (i.e., a linkage member) disposed on the inner member 10, a pair of (e.g., front and rear) rod support mechanisms 16 formed in the inner member 10, a rod biasing mechanism B formed in the inner member 10, and a pair of latching mechanisms L (i.e., a front or first latching mechanism LA and a rear or second latching mechanism LB) attached to the inner member 10.

As shown in FIGS. 4 and 6, the manipulation knob 40 may be slidably received in a knob receiving recess 14 formed in a front periphery of the inner member 10. The manipulation knob 40 may be arranged and constructed to move or reciprocate back and forth (i.e., in the forward and backward direction). The rod 50 may be positioned behind the manipulation knob 40 so as to extend over the substantially entire length of the inner member 10. The rod support mechanisms 16 may be formed in the upper surface of the inner member 10 at a certain interval in the front-back direction (i.e., the forward and backward direction) in order to slidably support the rod 50. The rod support mechanisms 16 may allow the rod 50 to move or reciprocate back and forth. Further, the rod support mechanisms 16 may each have the substantially same structure. The rod biasing mechanism B may be formed in the upper surface of the inner member 10. The rod biasing mechanism B may preferably be positioned between the rod support mechanisms 16. The rod support mechanisms 16 and the rod biasing mechanism B may preferably be aligned with the manipulation knob 40 in the front-back direction. The latching mechanisms L (LA and LB) may respectively be positioned in a front left corner and a rear left corner of the inner member 10.

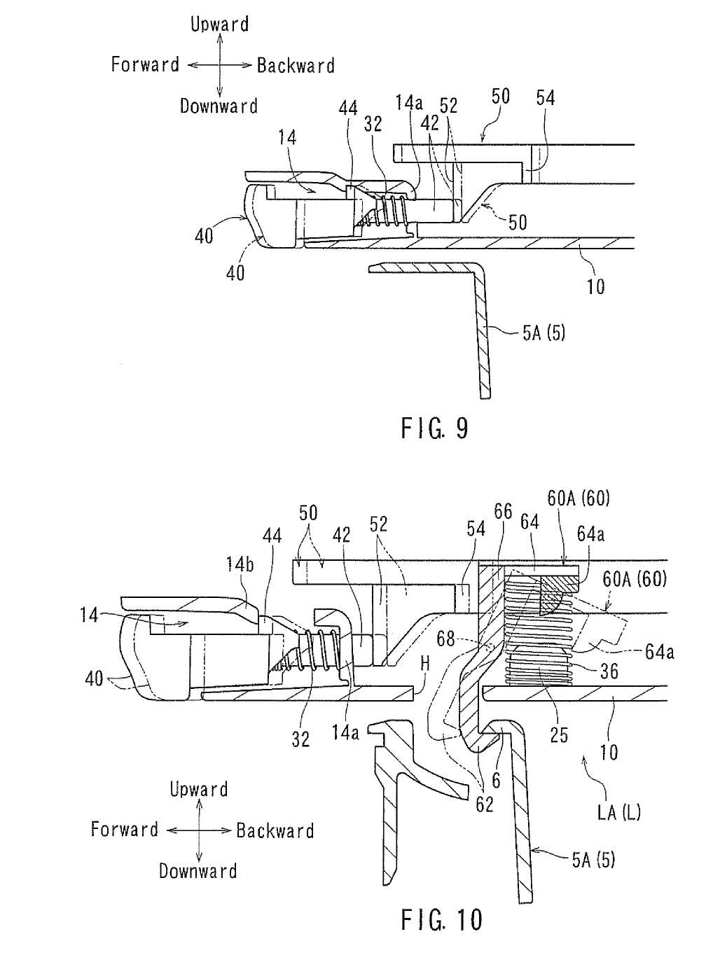

As shown in FIG. 6, the manipulation knob 40 may have a shaft portion 42 projected backward from a knob body and a pair of detent projections 44 formed in the knob body. As shown in FIG. 9, the shaft portion 42 may penetrate a rear wall 14a of the knob receiving recess 14 and project toward the rod 50 therethrough. Further, the manipulation knob 40 may have a (first) biasing member or return spring (compression spring) 32 that is attached to or journaled on the shaft portion 42. The return spring 32 may be positioned between the knob body of the manipulation knob 40 and the rear wall 14a of the knob receiving recess 14, so as to bias or press the knob body forward. Conversely, as shown in FIG. 10, the detent projections 44 may be arranged and constructed to respectively contact or engage detent strips 14b formed in the knob receiving recess 14 when the knob body of the knob 40 is pressed forward. Thus, as shown by solid line in FIG. 10, the knob body (the knob 40) pressed forward by the return spring 32 may be held in a predetermined position or initial position while the detent projections 44 contact the detent strips 14b.

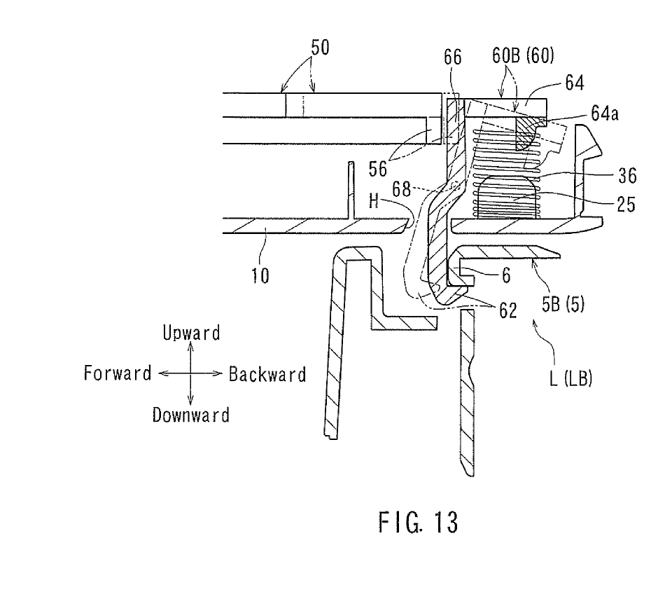

The rod 50 may have a knob-contacting portion 52 (FIG. 9), a first striker-contacting portion 54 (FIG. 10), a second striker-contacting portion 56 (FIG. 13), and a spring-contacting portion 58 (FIG. 12). The rod 50 may be associated with the manipulation knob 40, the rod support mechanisms 16, the rod biasing mechanism B and the latching mechanisms L, which will be hereinafter described in detail.

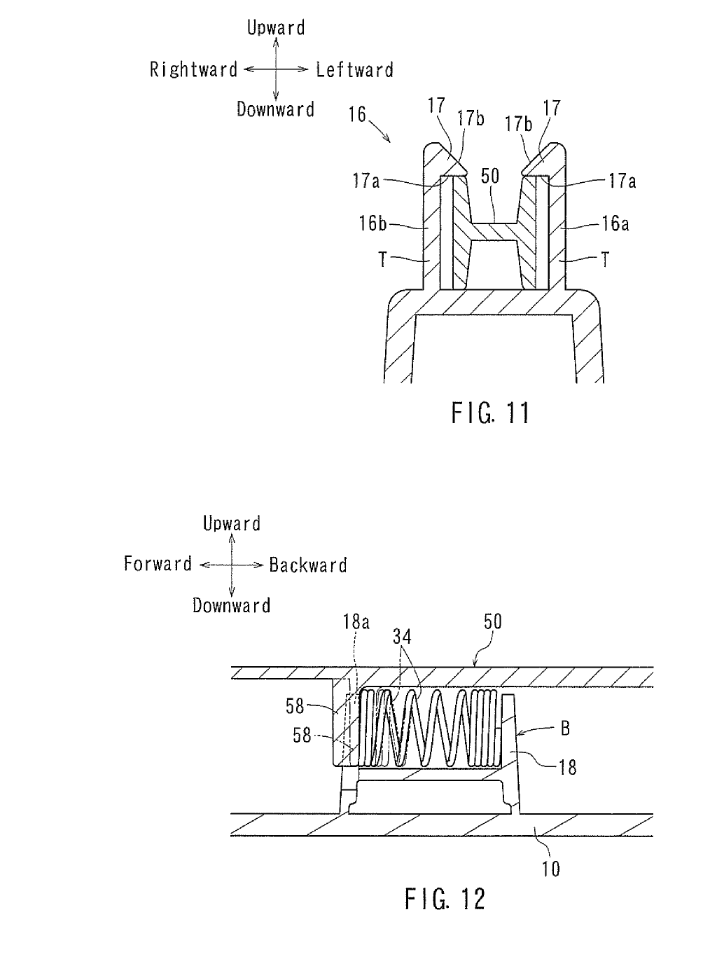

As shown in FIG. 11, each of the rod support mechanisms 16 may have a pair of (right and left) vertical walls 16a and 16b that are positioned opposite to each other and properly spaced. The vertical walls 16a and 16b may respectively be composed of vertical wall body portions T and engagement claws 17 formed in upper peripheries of the vertical wall body portions T. The vertical wall body portions T may be positioned laterally opposite to each other so as to form a groove therebetween. The rod 50 is received in the groove. Thus, the rod 50 may be slidably supported by each of the rod support mechanisms 16.

Further, the engagement claws 17 of the vertical walls 16a and 16b may be inwardly projected opposite to each other. The engagement claws 17 may respectively have lower stopper surfaces 17a and upper guide surfaces 17b. The stopper surfaces 17a may respectively be perpendicular to the vertical wall body portions T. The guide surfaces 17b may respectively be inclined inwardly and downwardly. The stopper surfaces 17a may function to contact the rod 50 received between the vertical wall body portions T and to prevent the rod 50 from coming off the groove formed between the vertical wall body portions T. Conversely, the guide surfaces 17b may function to guide the rod 50 when the rod 50 is introduced into the groove between the vertical wall body portions T from above. Further, the vertical wall body portions T (the vertical walls 16a and 16b) may be configured to be laterally flexed (i.e., flexed in the rightward and leftward directions).

As shown in FIG. 12, the rod biasing mechanism B may be composed of an elongated open-topped box-shaped portion 18 and a (second) biasing member or return spring (compression spring) 34. The box-shaped portion 18 may have a notch or slot 18a formed in a front wall thereof. The return spring 34 may be disposed within the box-shaped portion 18. The return spring 34 may contact the spring-contacting portion 58 of the rod 50 via the slot 18a formed in the box-shaped portion 18. Thus, as shown by solid line in FIG. 12, the rod 50 may be biased forward by the return spring 34, so as to be held in a normal or initial position thereof. Further, the initial position of the rod 50 may correspond to the initial position of the knob 40. In the initial position of the rod 50, the knob-contacting portion 52 of the rod 50 may engage or contact the shaft portion 42 of the knob 40 (FIG. 10).

The latching mechanisms L (LA and LB) may have substantially the same structure as each other. As shown in FIGS. 10 and 13, the latching mechanisms L (LA and LB) may respectively be composed of strikers 60 (a first striker 60A in LA and a second striker 60B in LB) and (third) biasing member or return springs (compression springs) 36. As shown in FIGS. 4 and 6, the strikers 60 (i.e., 60A and 60B) may respectively be rotatably attached to (front and rear) striker-supporting portions 20 formed in the inner member 10. In particular, each of the strikers 60 may have support pins 68. The support pins 68 may be formed in a central portion of each of the strikers 60 so as to be laterally oppositely projected therefrom. Conversely, each of the striker-supporting portions 20 may be composed of a pair of (right and left) vertical support walls 20a and 20b that are positioned opposite to each other and properly spaced (see FIG. 6). The support walls 20a and 20b may respectively have horizontal through holes 21 formed therein. The through holes 21 may be transversely aligned with each other. Each of the strikers 60 may be positioned between the support walls 20a and 20b while the support pins 68 are respectively introduced into the through holes 21. Thus, the strikers 60 may respectively be attached to the striker-supporting portions 20 so as to rotate about the support pins 68 in the front-back direction.

Further, as shown in FIG. 6, the support walls 20a and 20b of each of the striker-supporting portions 20 may respectively have vertical grooves 22 formed in their inner surfaces opposite to each other. The vertical grooves 22 may vertically extend from end surfaces of the support walls 20a and 20b so as to be continuous with the through holes 21. As will be recognized, the vertical grooves 22 may function to guide the support pins 68 when the support pins 68 are introduced into the through holes 21 in order to attach each of the strikers 60 to each of the striker-supporting portions 20.

As shown in FIGS. 10 and 13, the strikers 60 attached to the striker-supporting portions 20 may respectively be introduced into communicating holes H formed in the inner member 10 such that lower portions thereof may be projected downward beyond a lower surface of the inner member 10. The strikers 60 (60A and 60B) may respectively have hook-like engagement claws 62 that are respectively formed in lower ends of the strikers 60. As shown in FIGS. 10 and 13, the engagement claws 62 of the strikers 60A and 60B may be arranged and constructed to respectively engage hook-like engagement portions 6 formed in the lid attaching members 5 (5A and 5B) in a (closed) condition in which the lid 1 is closed, i.e., in a (closed) condition in which the opening 105a of the storage portion 105 is closed or covered by the lid 1 (FIG. 1).

As shown in FIGS. 10 and 13, each of the strikers 60 may be rotatable between a latched or initial position in which each of the engagement claws 62 of the strikers 60 may engage each of the engagement portions 6 of the lid attaching members 5 and an unlatched or released position in which each of the engagement claws 62 may be disengaged from each of the engagement portions 6 of the lid attaching members 5. Further, in the condition in which the lid 1 is closed (FIG. 1), each of the strikers 60 may be positioned in the initial position, so that the engagement claws 62 of the strikers 60 may respectively engage the engagement portions 6 formed in the lid attaching members 5 (FIGS. 10 and 13). As a result, the lid 1 may be locked or fastened to the consol body 103 so as to be held in a locked or fastened condition. Conversely, in the fastened condition in which the lid 1 is fastened to the consol body 103, upon rotation of each of the strikers 60 to the released position, the engagement claws 62 of the strikers 60 may respectively be disengaged from the engagement portions 6 formed in the lid attaching members 5. As a result, the lid 1 may be unfastened or released from the consol body 103 so as to be held in a released or unfastened condition. Further, in FIGS. 10 and 13, the initial position and the released position of each of the strikers 60 may respectively be shown by solid line and broken line, respectively.

As shown in FIGS. 6, 10 and 13, the strikers 60 (60A and 60B) may respectively have spring retaining portions 64. Each of the spring retaining portions 64 may be formed in an upper end of each of the strikers 60. Each of the spring retaining portions 64 may be projected backward from the upper end of each of the strikers 60. The return springs 36 may respectively be retained between the spring retaining portions 64 and the inner member 10. In particular, the return springs 36 may respectively be retained between the spring retaining portions 64 and the inner member 10 while each of the return springs 36 engages each of retaining projections 64a formed in the spring retaining portions 64 and each of retaining protrusions 25 formed in the inner member 10 at both ends. Each of the return springs 36 thus retained may function to bias each of the strikers 60 to the initial position. Therefore, each of the strikers 60 may normally be held in the initial position.

As shown in FIGS. 6, 10 and 13, the strikers 60A and 60B (60) may respectively have contacting portions 66. Each of the contacting portions 66 may be formed in an upper portion of each of the strikers 60. The contacting portions 66 of the strikers 60A and 60B may be arranged and constructed to respectively engage or contact the first striker-contacting portion 54 and the second striker-contacting portion 56 of the rod 50. Therefore, in a condition in which each of the strikers 60 is held in the initial position, when the rod 50 may be pressed backward, the contacting portions 66 of the strikers 60 may respectively be pressed backward via the first and second striker-contacting portions 54 and 56 of the rod 50, so that each of the strikers 60 may be rotated to the released position.

An operation of the fastening device thus constructed will now be described with reference to FIGS. 9 to 13.

First, in the condition in which the lid 1 is closed (FIG. 1), the latching mechanisms L (LA and LB) may be activated. As a result, the lid 1 may be locked or fastened to the consol body 103. In particular, when the lid 1 is closed, each of the strikers 60 may be held in the initial position, so that each of the engagement claws 62 of the strikers 60 may engage each of the engagement portions 6 formed in the lid attaching members 5 fixed to the consol body 103 (FIGS. 10 and 13). Thus, the lid 1 may be locked or fastened via the latching mechanisms L.

In order to release or unfasten the lid 1, the manipulation knob 40 positioned in the initial position may be pressed or pushed backward against a biasing or spring force of the return spring 32. As a result, as shown by broken line in FIGS. 9 and 10, the knob-contacting portion 52 of the rod 50 positioned in the initial position may be pressed backward via the shaft portion 42 of the knob 40, so that the rod 50 may slide or move backward against a biasing or spring force of the return spring 34. Due to a sliding motion of the rod 50 (i.e., due to actuation of the linkage member), the first and second striker-contacting portions 54 and 56 of the rod 50 may move backward, so as to respectively press the contacting portions 66 of the first and second strikers 60A and 60B backward (broken line in FIGS. 10 and 13). As a result, each of the strikers 60A and 60B may be rotated from the initial position (solid line in FIGS. 10 and 13) to the released position (broken line in FIGS. 10 and 13) against a spring force of each of the return springs 36, so that each of the engagement claws 62 of the strikers 60 may be disengaged from each of the engagement portions 6 formed in the lid attaching members 5 (i.e., the latching mechanisms L (LA and LB) may be deactivated). Further, the strikers 60A and 60B may be rotated in synchrony with each other. Thus, the lid 1 may be released or unfastened.

Further, upon release of the manipulation knob 40, the knob 40 may be automatically returned to the initial position by the spring force of the return spring 32. Simultaneously, the rod 50 may be returned to the initial position by the spring force of the return spring 34. As a result, each of the strikers 60A and 60B may be returned to the initial position by the spring force of each of the return springs 36.

Next, a representative process or method for incorporating the fastening device (the manipulation knob 40, the rod 50, the return springs 32, 34 and 36, and the strikers 60) into the lid 1 (the inner member 10) will be described.

First, the return spring 32 may be attached to the shaft portion 42 of the manipulation knob 40. The manipulation knob 40 thus constructed may then be inserted into the knob receiving recess 14 previously formed in the inner member 10. Thereafter, the return spring 34 may be received within the box-shaped portion 18 previously formed in the inner member 10 from above. Subsequently, the rod 50 may be attached to the rod support mechanisms 16 previously formed in the inner member 10. In particular, the rod 50 may be pushed between the vertical walls 16a and 16b of each of the rod support mechanisms 16 from above while the spring-contacting portion 58 of the rod 50 contacts the return spring 34 received within the box-shaped portion 18.

Finally, the strikers 60 may respectively be attached to the striker-supporting portions 20 previously formed in the inner member 10 while each of the return springs 36 engages each of the retaining projections 64a formed in the spring retaining portions 64 and each of the retaining protrusions 25 formed in the inner member 10. In particular, each of the strikers 60 may be attached to the support walls 20a and 20b of each of the striker-supporting portions 20 while the support pins 68 are respectively introduced into the through holes 21 formed in the support walls 20a and 20b. Further, in order to introduce the support pins 68 into the through holes 21, each of the strikers 60 may be simply pressed down while sliding the support pins 68 along the vertical grooves 22 formed in the support walls 20a and 20b.

According to the fastening device of the present invention, elements of the fastening device may be easily attached to the inner member 10 of the lid 1 without using a specialized tool or jig.

Various changes and modifications may be made to the present disclosure without departing from the scope thereof. For example, in the embodiment, the compression spring is used as each of the return springs 32, 34 and 36. However, a leaf spring may be used as each of the return springs 32, 34 and 36 provided that such a spring may function to bias each of the knob 40, the rod 50 and the strikers 60 to the initial position.

Further, the lid attaching members 5 may be arranged and constructed such that the lid 1 may be opened and closed to right and left about a left periphery of the opening 105a. In such a modified structure, the lid attaching members 5 and the inner member 10 may respectively be reverted right to left.

Further, the fastening device of the present invention may be applied to various types of lids other than the lid 1 of the center consol box 100. For example, the fastening device of the present invention may be applied to a lid of a glove box or other such lids. In addition, the fastening device of the present invention may be applied to lids of storage boxes or compartments used in various equipments other than vehicles.

A representative example has been described in detail with reference to the attached drawings. This detailed description is merely intended to teach a person of skill in the art further details for practicing preferred aspects of the present disclosure and is not intended to limit the scope of the invention. Only the claims define the scope of the claimed invention. Therefore, combinations of features and steps disclosed in the foregoing detailed description may not be necessary to practice the invention in the broadest sense, and are instead taught merely to particularly describe detailed representative examples of the invention. Moreover, the various features taught in this specification may be combined in ways that are not specifically enumerated in order to obtain additional useful embodiments.

What is claimed is:

1. A lid fastening device that is configured to fasten a lid attached to an object member and capable of opening and closing an opening formed in the object member, the lid fastening device comprising:
a knob;
a rod configured to slide from an initial rod position when the knob is pushed;
a plurality of strikers, each of which has an engagement claw capable of engaging each of engagement portions formed in the object member and is configured to rotate between an initial striker position in which each of the engagement claws engages each of the engagement portions of the object member to produce a fastened condition of the lid and a released position in which the fastened condition of the lid is released due to a sliding motion of the rod; and
a plurality of first return springs each of which is configured to bias each of the strikers rotated to the released position so as to return the strikers to the initial striker position, wherein the initial striker position of each striker corresponds with the initial rod position.

2. The lid fastening device of claim 1, wherein the rod is slidably attached to the lid, and wherein the rod engages the strikers so as to rotate the strikers in synchrony with each other.

3. The lid fastening device of claim 2, wherein the rod is held in the initial rod position by a second return spring attached to the lid.

4. The lid fastening device of claim 1, wherein the knob is slidably attached to the lid, and wherein the knob is held in an initial position by a second return spring attached to the lid.

5. A lid fastening device that is configured to be incorporated into a lid of a storage compartment, the lid fastening device comprising:
a plurality of latching mechanisms attached to the lid; and
a linkage member movably attached to the lid and linked with the latching mechanisms;
wherein when the lid is closed, the latching mechanisms are activated, so that the lid is fastened; and
wherein actuation of the linkage member causes the latching mechanisms to be deactivated, so that the lid is unfastened.

6. The lid fastening device of claim 5, wherein each of the latching mechanisms comprises a striker;
wherein the linkage member comprises a rod slidably attached to the lid and linked with each striker;
wherein when the lid is closed, each striker is engaged with the main body of the storage compartment; and
wherein each of the strikers is configured to be disengaged from the main body of the storage compartment due to a sliding motion of the rod.

7. The lid fastening device of claim 5, wherein each of the strikers has an engagement claw capable of engaging a corresponding engagement portion formed in the main body of the storage compartment.
